(19) United States
(12) Patent Application Publication
(10) Pub. No.: US 2022/0024125 A1
(43) Pub. Date: Jan. 27, 2022

(54) METHOD FOR TREATMENT OF ELEMENTS OBTAINED BY AN ADDITIVE MANUFACTURING PROCESS

(71) Applicant: TECHNISCHE UNIVERSITÄT MÜNCHEN, München (DE)

(72) Inventor: Tobias Abstreiter, Lengdorf (DE)

(21) Appl. No.: 17/292,737

(22) PCT Filed: Oct. 24, 2019
(86) PCT No.: PCT/EP2019/079116

§ 371 Date: May 11, 2021

(51) Int. Cl. B29C 64/188; B29C 64/321; B33Y 40/20; B33Y 70/00; B29C 71/00

(52) U.S. Cl. CPC B29C 64/188; B29C 64/321; B29K 2077/00; B33Y 70/00; B29C 71/0009; B33Y 40/20

(57) ABSTRACT

A method for treatment of polymer elements obtained by an additive manufacturing process comprises applying to the polymer element a treating liquid in liquid form.

The present invention is concerned with a method for treatment of elements, in particular as bulk material obtained by an additive manufacturing process.

Additive processes for producing elements for various applications have become very popular. Additive processes, also known as three-dimensional (3D) printing processes are available in different forms starting from building materials in liquid, viscous, solid or powder form. Fused filament fabrication (FFF) uses a continuous filament of a thermoplastic material which in molten form is deposited on the growing workpiece.

Another type of 3D printing processes uses building material in powder form which is selectively solidified by sintering, melting, fusing, or binding the powder at selected sites for producing elements. Said elements are built by depositing powdery building material layer after layer. The building material can be a polymer, a metal, a ceramic, or a composite material. One class of polymers that is useful for additive manufacturing is the class of polyamide polymers and polyamide blends. An element is formed by applying a layer of building material in powder form to a building platform, and then based on computer generated data selectively heating or bonding the powder in those parts of the layer which shall become part of the element. For example the powder can be fused or melted by infrared radiation, sintered by a laser beam, or bonded by a binder material. The platform is then lowered, another layer of building material in powder form is added and again melted, fused, or bonded. These steps are repeated until the element has been built.

Selective heating can be obtained by a laser beam, as for example in selective laser sintering (SLS), or by infrared radiation, such as in multi-jet fusion (MJF) processes including high speed sintering (HSS). Selective solidifying can be obtained by binder-jetting processes among others. The main principle of these solidifying processes is the use of a powder which is treated to solidify at predetermined sites to yield the element. Additive sintering processes are particularly useful for producing elements with delicate structures, fine channels and/or complex forms.

Building materials used in additive processes are often polymers and the quality of the elements obtained in these processes depends on the polymer used. A class of polymers that is highly desirable for additive manufacturing is polyamide, a highly robust polymer which is resistant to the environment and has good mechanical properties. Therefore, polyamide in powder form is a useful building material and is used in multi-jet fusion (MJF), HSS and selective laser sintering (SLS) processes. Other known processes use light for solidifying photoreactive liquid resin, for example laser-based stereolithography (SLA) and digital light processing (DLP). Another known process is Multijet-Modeling (MJM) where material is heated and “trickled” out of Nano-Jets on the building platform, hardened and cured with UV light.

Other materials that are useful in sintering processes are thermoplastic polymers like thermoplastic elastomers, such as thermoplastic polyurethane (TPU), thermoplastic polyamides (TPA), thermoplastic copolyester compounds (TPC) among others. Those polymers have desirable properties, however when used for 3D printing the elements obtained often have a rough surface with a roughness that can be up to 20 μm and more.

Although additive manufacturing processes as known in the art are very useful because they save time and cost as compared to manufacturing processes using traditional methods, one disadvantage of these very useful techniques is that the surface smoothness of the obtained elements is not satisfying. The surface of the elements obtained has a surface roughness Rₐ which, depending on the manufacturing process used, can be in the range of up to 10 μm or even up to 20 μm or beyond. Therefore, for many applications it is necessary to smoothen the elements' surface before the elements can be used. Methods for smoothing the surface are known, but all have disadvantages and are detrimental to the structure and/or to the mechanical strength of the elements.

US 2017/0327658 discloses a process for surface treatment of an object wherein the object is dipped into concentrated acid to impregnate the surface and then is heated to a temperature between 140 and 180° C., until melting of the surface is obtained. This treatment is very harsh and can result in formation of holes or cracks in the surface.

DE 10 2014 102 137 discloses a process for treatment and dyeing of surfaces wherein an object is dipped into a hot solution comprising a dye for up to 6 hours wherein the dye solution has a temperature between 60 and 180° C. The process comprises at least three steps wherein in a first step the objects are pretreated by milling, grinding or polishing. After this step formic acid vapor can be applied to further smoothen the surface. In a second step the objects are dyed by using a mixture of dye and water having a temperature of at least 60° and up to 180° C. In a third step the surface of the object is impregnated and/or sealed by applying a polymer solution. This process has disadvantages. Mechanical treatment such as milling, grinding and polishing, and the use of formic acid at high temperatures, can damage or deteriorate elements or parts thereof. Such treatment is particularly undesirable for elements having delicate parts, channels, holes etc., because those parts or sites can be destroyed or at least impaired or damaged. On the other hand, the use of formic acid vapor is undesirable; precautions have to be taken to avoid that formic acid vapor escapes into the atmosphere.

As on the one hand elements obtained by additive manufacturing processes are very promising and are produced in increasing amounts, and on the other hand a high quality surface is necessary, it was an object of the present invention to provide a process for smoothing, refining or finishing the surface of an element obtained by an additive manufacturing process which does not or essentially not damage the surface, maintains the complexity of the structure and form of the element, can be carried out in short time and avoids the use of mechanical steps, such as milling, grinding or polishing.

Moreover, it was an object of the present invention to provide a method for treating bulk material obtained by additive manufacturing processes. It is desirable to treat elements obtained by additive manufacturing processes as a bulk material but this was not possible until now as with the methods known in the prior art surfaces become adhesive by treatment and elements adhere to each other.

Moreover, it was an object of the present invention to provide a method for treating bulk material by using environmentally friendly materials and to avoid use of higher amounts of organic solvents that are detrimental to the environment.

Furthermore it was an object of the present invention to provide a method which can be used for delicate parts as well as bulky parts. To allow a treatment of delicate parts with a solvent it is necessary to exactly determine the treatment period. Therefore, a method should be provided where reactivity can be adapted exactly and easily.

In other words it was an object of the present invention to provide a method for treating single polymer elements and bulk material, i.e. a plurality of elements at the same time in the same process, that can be used for smoothing and optionally also functionalizing elements made from many different types of polymers and in particular for polyamide based polymers and copolymers.

It was found that it is possible to provide elements obtained by an additive manufacturing process with a smooth surface by treating the elements with a method as defined in claim 1, which allows smoothing surfaces of elements with very delicate parts, with high complexity, with channels, holes and fine structures in a timely manner and at convenient temperatures. Moreover, it is possible to treat the surface of those elements to provide it with desirable functions. The parts have high quality and the mechanical strength is not or hardly impaired by the method according to the present invention.

It was surprisingly found that a liquid mixture of water and alcohol in predetermined ratios at a predetermined temperature and for a predetermined time period allows smoothing the surface of elements in an efficient way and allows treating a plurality of elements all at the same time as well as bulk material, as elements flow in the treating liquid and do not adhere to each other. Start and stop of the smoothing reaction can be controlled by controlling temperature regime and time of treatment. Thus, it is possible to exactly control the whole process to avoid softening of surfaces, deterioration of surfaces, rounding and softening of contour lines. In addition, it was surprisingly found that by using the method of the present invention it is possible for those elements that comprise carbon black to change the color of the surface which allows dyeing elements in many color tones during the process or in a further step of the process.

The method of the present invention can be used for elements that have been obtained by additive manufacturing processes, wherein a polymer is used as building material to form an element. Valuable building materials are different types of thermoplastic polymers, such as different types of polyamide and polymers like PMMA, POM, PC, PEI, PSU, or polybutylene-terephthalate (PBT), or a thermoplastic elastomer, such as thermoplastic polyurethane (TPU), thermoplastic polyamide (TPA), thermoplastic copolyester compound (TPC), or thermoplastic styrene block copolymers (TPS), such as styrene/ethylene/butylene/styrene block copolymer (SEBS), or acrylic polymers like acrylonitrile-butadiene-styrene (ABS), acrylic ester-styrene-acrylonitrile (ASA). Although the method of the present invention is valuable for many different types of polymers, it is particularly useful for elements obtained by manufacturing of polyamide based polymers and copolymers.

Elements that can be treated are those that have been built as described above for example by MJF, HSS, SLS, FFF, or binder jetting processes using polymer powder as building material and an energy source like laser or infrared radiation, heating etc. for solidifying, to create a solid structure from the powder. Examples are binder jetting processes using PMMA as building material and a binder for creating the solid structure, or using PC, POM, PSU, or PEI as building material and an FFF process for creating the solid structure. The method of the present invention surprisingly is useful for treating elements prepared from thermoplastic polymer powder. Also elements obtained with DLP, SLA and MJM processes can be treated by the method of the present invention. Powder based printing processes like MJF, HSS and SLS are particularly useful for preparing complicated elements with very delicate structures, as the powder bed supports the elements. The elements obtained thereby can be treated with the method of the present invention.

The method as defined in the claims is versatile and allows adapting the conditions according to the properties that are desirable for an element. Moreover, the method of the present invention provides a surface that is very well suited for being dyed or functionalized.

Definitions

The term “additive manufacturing” as used in the present application, comprises various processes in which polymer material, in particular polymer powder, is processed under computer control to create three-dimensional objects. It includes sintering as well as binder jetting or FFF processes. It includes processes where a polymer powder is first melted, fused, sintered, or bonded and then solidified at predetermined sites. In other words, it is a process, where a solid element is formed layer by layer from building materials like thermoplastic elastomers or polyamides. It also comprises light induced processes like SLA, DLP and MJM. In particular, the term “additive manufacturing” as used in the present application, comprises a process where a polymer powder is solidified in a predetermined shape or pattern to build an object or element.

The term “powder-based additive manufacturing” as used in the present application refers to additive manufacturing processes that use polymers in powder form as building material.

The term “element” as used in the present application refers to a product that has been obtained by additive manufacturing. An element can be made or can be comprised of any usable polymer, in particular of a polyamide based polymer or copolymer.

The term “polymer” as used in the present application comprises polymers obtained from one type of monomer or from two or more types of monomers. It comprises homopolymers, copolymers, blockpolymers and mixtures of different types of polymers.

The term “polyamide element” as used in the present application refers to an element that has been obtained by an additive manufacturing process by using polyamide or a material comprising polyamide as building material.

The term “polyamide” as used in the present application comprises one type of polyamide, a mixture of two or more types of polyamide, polyamide copolymers such as PA6/PPO, as well as polyamide blends. It also comprises polymers known as “nylon”.

The term “polyamide powder” as used in the present application comprises one type of polyamide powder or a powder mixture of two or more types of polyamide as well as polyamide blends, i.e. blends of one or more polyamide powders with other powders, like other polymer powders, metal powders, ceramic powders, fibers, etc.

The term “thermoplastic polymer” as used in the present application comprises thermoplastic elastomers, such as thermoplastic polyurethane (TPU), thermoplastic polyamides (TPA), thermoplastic polyetheramides such as PEBA among others. The term thermoplastic polymers also comprises polymers like ABS and PEI. In particular, the term comprises those thermoplastic polymers or elastomers, respectively, that are suitable for powder-based additive manufacturing processes.

The term “thermoplastic polymer powder” as used in the present application comprises one or more types of powder of thermoplastic polymers, such as a powder of one type of such a polymer or a powder mixture of two or more types of thermoplastic polymer powders as well as polymer blends, i.e. blends of one or more thermoplastic polymer powders with other powders, like other polymer powders, metal powders, ceramic powders, fibers, etc.

A “lower threshold temperature” as used in the present application is a temperature which when exceeded results in smoothing of the element. Smoothing may start slowly but recognizably at about the lower threshold temperature smoothing when an element is being treated with a treating liquid above the lower threshold temperature. The lower threshold temperature is dependent on the polymer of the element, the element's size and shape, the treating liquid, and the pressure in the treatment container.

An “upper threshold temperature” as used in the present application is a temperature beyond which the element is at least partially distorted or destroyed; it is dependent on the specific treating liquid, the polymer and its melting temperature. The upper threshold temperature is below the melting point or range of the polymer, respectively. Lower and upper threshold temperature can be determined as shown below.

When a temperature is indicated for application of a liquid or treatment with a liquid, the temperature refers to the temperature of this liquid. The application of a “liquid at x° C.” means that the liquid has temperature x° C., when it is applied and that the temperature of the liquid is maintained for the indicated time period, for example by heating means, such as a heating bath.

The terms “room temperature” or “ambient temperature” as used in the present application refer to a temperature of about 20° C.

When the term “applying” or “application” is used with regard to the treatment with a treating liquid as defined in claim 1, this shall mean that the treating liquid is applied on the element such that the element is fully or partially wetted or contacted by the treating liquid. This can be obtained by means as known to the skilled person, for example by dipping the elements into the treating liquid such that the elements are fully surrounded by the treating liquid or such that selected parts of the elements are wetted by the treating liquid. It is important that the treating liquid contacts the whole surface of an element and can also flow into channels, holes etc., or, if intended, contacts selected parts of an element's surface.

A time period for application of the treating liquid is the time period wherein the treating liquid is in contact with the element at the predetermined temperature or until removal of the solvent or the element, respectively. Time periods for heating and smoothing are those time periods wherein the heating liquid or treating liquid, respectively, have the indicated temperature and are in contact with the elements.

The term “treating liquid” as used in the present application refers to a liquid mixture comprising water and at least one monovalent aliphatic alcohol for treating at least one element.

A water-alcohol-mixture is an aqueous mixture comprising at least one monovalent aliphatic alcohol. A water-alcohol-mixture can comprise a combination of two or more monovalent aliphatic alcohols.

A weight ratio of water and alcohol refers to the ratio between water and the total amount of monovalent aliphatic alcohol(s). The ratio of water and alcohol is indicated as percentage and refers to percent by weight. A water-alcohol-mixture can comprise as main ingredients water and at least one type of monovalent aliphatic alcohol and optionally can comprise additionally additives like one or more further solvents which can be for example aromatic alcohols, in lower amounts.

A polyvalent alcohol is an organic compound carrying at least two OH groups and can optionally have further substituents or functional groups as defined above. Examples are glycol, glycerol, triethyleneglycol amongst others.

When it is generally referred to “alcohol” in this application, this term comprises at least one alcohol as defined above and also comprises a mixture of alcohols.

The term “additional solvent” as used in the present application comprises a single organic solvent or a mixture of two or more solvents that are used in addition to the water-alcohol-mixture and does not comprise water or a monovalent aliphatic alcohol, although it can comprise aromatic alcohols.

Any amount of additional solvent, such as polyvalent or aromatic alcohol is added additionally to the amount of treating liquid. Any additional solvent and/or plasticizer can be present in the treating liquid in an amount of up to 20 wt.-%, such as up to 10 weight-%, based on the weight of the amount of treating liquid.

The term “plasticizer” as used in the present application refers to a compound that increases plasticity of a material, in particular that increases flexibility of polymers for example by decreasing attraction between polymer chains. Examples for plasticizers are aromatic esters such as phthalates, benzoates, aliphatic esters such as citrates, adipates, sebacates, cycloaliphatic esters such as cyclohexane dicarboxylic acid alkyl esters. The term “plasticizer” also comprises bio-based compounds like oil derived compounds, for example soybean oil derivatives, or essential oils like campher.

The term “functionalizing agent” as used in the present application refers to an agent that adds or introduces a function to the element or to the surface of the element, respectively. The function can be a chemical, physical, esthetical, protective etc. function.

“Solidifying” of a powder can be obtained by fusing, sintering, melting, or binding a powder.

The term “chamber” as used in the present application refers to a treatment chamber wherein the elements are treated. The chamber can be any type of a container that is suitable for the application of a treating liquid and preferably comprises heating means, examples are an external or internal microwave unit or ultrasound unit. It can be a pressure chamber.

The surface roughness of a material or element refers to the texture on the surface. It is quantified by deviations in the profile, i.e. deviations in a direction that is normal to the surface. Measured values for the profile result from scanning the actual profile with a probe. Surface imperfections, such as cracks, scratches and dents, should not be part of the profile and should not be included in the measured value. Roughness parameters that are usually used are Rₐ—arithmetical mean roughness value, wherein the arithmetical mean of the absolute values of the profile deviations from the mean line of the roughness profile is measured, or R_{z}—mean roughness depth, where the mean value of i (usually i=5) profile deviations from i sampling length is measured.

In the present application, when it is referred to surface roughness, this refers to Rₐ values, i.e. arithmetical mean roughness values except the context tells otherwise.

The method of the present invention comprises the treatment of elements by applying a treating liquid. It has surprisingly been found that the surface of elements can be smoothed by applying a treating liquid comprising water and at least one alcohol as defined before at a predetermined temperature and for a predetermined time period. The method of the present invention is suitable for treating bulk material, which is understood as treating a number of elements together within said time period and not separated in steps or separated by separation devices.

The method of the present invention comprises at least three steps—a) a heating step, b) a smoothing step and c) a cooling step as defined in claim 1, and can comprise further steps like a pretreatment step, a post treatment step, a functionalizing step, among others.

Thus, the method for treatment of polymer elements obtained by an additive manufacturing process comprises
a) a heating step for heating a treating liquid to a temperature below an upper threshold temperature, wherein the upper threshold temperature is in a range of about 1° C. to about 80° C. below the melting temperature of the polymer from which the polymer elements are formed,
b) a smoothing step wherein the polymer elements are in contact with the treating liquid at a temperature above a lower threshold temperature and below the upper threshold temperature for a predetermined time period, under conditions where the treating liquid is in liquid form,
c) a cooling step for cooling the polymer elements, preferably to a temperature at least 5° C. below the upper threshold temperature, more preferably to a temperature below the lower threshold temperature,
   wherein the treating liquid comprises water and at least one monovalent aliphatic alcohol, wherein the weight ratio of water to alcohol is in a range of about 98:2 to about 20:80.
   According to a preferred embodiment of the invention, the upper threshold temperature may be in a range of about 100° C. to about 190° C.

It was surprisingly found, that using a mixture of a monovalent aliphatic alcohol with water allows adapting a suitable time period for the smoothing reaction. It was found that there is a lower threshold temperature below which no or hardly no smoothing occurs. When after smoothing the temperature is decreased, for example by cooling, the smoothing action will become slower and stop. Below the lower threshold temperature no smoothing action occurs. It is dependent on the rate of cooling when smoothing stops as well as on the size and shape of the elements and the polymer used. The optimal smoothing time and cooling rate can be found with routine experiments.

The treating liquid preferably comprises water and alcohol, such as ethanol, in a weight ratio of about 98:2 to about 20:80, such as about 85:15 to about 40:60,

The method of the present invention is useful for any element that has been obtained by an additive manufacturing method from a polymer material, wherein the polymer material is softened or dissolved by a treating liquid in liquid form comprising water and at least one monovalent aliphatic alcohol. In particular, the method of the present invention can be applied for any element that has been obtained by an additive manufacturing method from a polymer material that is softened and/or dissolved by the treating liquid of the present invention at application temperature. Polymers that are used in additive manufacturing processes are known to the skilled person. Examples for polymers that can be used as building material to form an element are duroplastic or thermoplastic polymers. Materials that are particularly useful in powder-based additive manufacturing processes are thermoplastic polymers such as polyamides and thermoplastic elastomers. Examples of polymers and polymer classes that are useful are polyamide, acrylates such as polymethyl methacrylate (PMMA), polyoxy methylene (POM), polyethylene terephthalate (PET), polyethylene terephtalate glycol (PETG), polyether block amide (PEBA), poly carbonates (PC), polyethylene furanoate (PEF), polyurethanes such as thermoplastic polyurethane (TPU), polysulfones (PSU) such as polyethersulfones (PESU), and polyphenylsulfones (PPSU), polyimides, polyetherimides (PEI), styrene polymers and copolymers such as acrylonitrile butadiene styrene (ABS), acrylonitrile styrene acrylate (ASA), or triblock polymers of polystyrene and poly(ethylene oxide) blocks (ABA), or a thermoplastic polymer comprising polyetherimide and polycarbonate, which is available as Ultem 9085, or copolymers, blends, or mixtures of all above-mentioned materials. Furthermore, elements based on photopolymers can also be treated by the method of the present invention, i.e. elements that have been obtained with processes like stereolithography or polyjet where polymers are used for printing elements and are cured or post-cured, respectively, in a further step. It has been found that the method of the present invention can be used for this type of polymers also when the treating step is carried out before post-curing.

The method of the present invention is particularly useful for elements obtained from polyamide based polymers and copolymers. Polyamide is a valuable building material and it is used in different types. Suitable polyamides are aliphatic, semi-aromatic and aromatic polyamides, for example polyamide 12 (PA12), polyamide 6 (PA6), polyamide 6.6 (PA6.6), polyamide 11 (PA11), PA 4.6 (PA4.6), polyamide 612 (PA612), polyphthalamide (PPA), or thermoplastic co-polyamides, or blended or filled polyamides such as a blend with metal powder, for example a blend of aluminum powder and polyamide powder that is available as alumide, or polyamide powder filled with particles like glass particles, or copolymers, blends, or mixtures thereof. It has been found that PA12 or filled PA12 is particularly suited for a process as described and claimed.

Elements that can be smoothed by the method of the present invention can be for example those built as described above by MJF, HSS, SLS processes using polyamide powder as building material and an energy source like a laser or infrared radiation to create a solid structure from the powder, binder jetting processes using PMMA as building material and a binder for creating the solid structure, or using PC, POM, PSU as building material and an FFF process for creating the solid structure, or by light induced processes-such as MJM. MJF, HSS, and SLS are particularly useful for producing complicated elements with very delicate structures, as the powder bed supports the elements. Also elements obtained by granulate extrusion or pellet extrusion can be treated with the method of the present invention.

The elements are treated according to the present invention with a treating liquid which comprises at least one and can comprise two or more monovalent aliphatic alcohols, and/or further solvents and/or additives. It has been found that a treating liquid comprising a water-alcohol-mixture as defined in the claims is useful to treat the surface of elements obtained by additive manufacturing, in particular to smoothen and optionally to change properties of the surface like colour, gloss, structure, adhesiveness, anti-adhesiveness, electrostatic charge, electrical conductivity and/or to functionalize the surface or parts thereof. One or more alcohols can be used in liquid form, depending on the polymer to be treated.

Suitable alcohols are aliphatic C₁-C₁₀ alcohols. Examples for aliphatic C₁-C₁₀ alcohols that are well-suited as treating liquid are amongst others ethanol, isopropanol, propanol, n-, iso- or tert.butanol, methanol, or any mixture thereof. Ethanol is a monovalent alcohol that is very well suited for the method of the present invention.

According to a preferred embodiment of the invention, the treating liquid may comprise water and ethanol in a weight ratio of about 95:5 to about 30:70 and/or the treating liquid may be applied at a temperature in the range of about 120° C. to about 180° C. under conditions where the treating liquid is in liquid form.

It has been surprisingly found that the smoothing action of the treating liquid of the present invention in some cases can be improved by adding at least one plasticizer and/or at least one additional solvent. Therefore, for those elements that are difficult to smoothen or for which high temperature and/or high pressure were necessary, the addition of at least one plasticizer improves the results and might lower temperature and/or pressure to be applied.

Plasticizers are well-known to the skilled person. Preferably those are used that are not toxic. Suitable are in particular plasticizers that are compatible with the polymer used for preparing the elements. Examples for plasticizers are aromatic esters, aliphatic esters, cycloaliphatic esters, and bio-based compounds, such as phthalates, benzoates, citrates, adipates, sebacates, cyclohexane dicarboxylic acid alkyl esters, fatty oils, and essential oils.

The plasticizer is used in an amount that provides for an improvement of the desired effect. An amount of about 0.1 to about 20 weight-%, such as about 1 to about 10 weight-%, for example 2 to 7.5 weight-%, based on the total weight of the treating liquid, can be used.

Furthermore, the treating liquid can comprise at least one additional solvent to improve the smoothing effect. Without being bound by theory it is assumed that the additional solvent has the function of a solubilizer, i.e. supports and fosters the smoothing action of the alcohol. Therefore, the additional solvent can be a solvent that is compatible with the polymer used for preparing the element and the water-alcohol-mixture. Solvents that have been found useful can be selected from substituted or unsubstituted aromatic C₆-C₁₂ alcohols, polyvalent alcohols selected from glycerol and glycols, esters, ethers, ketones, lactones, and DMSO, or mixtures thereof, wherein preferably the solvent is DMSO or γ-butyrolactone.

The amount of the additional solvent depends on the compatibility and on the effect. It can be as few as about 0.5 weight-% or less and up to about 20 weight-%, such as up to about 10 weight-%.

The treating liquid can comprise plasticizer and/or additional solvent. It has been found that when adding plasticizer to the treating liquid the lower and/or upper threshold temperature can be decreased by up to 10° C., whereas by adding for example a polyvalent alcohol, such as glycerol, the upper threshold temperature can be increased. Sometimes it is useful to increase or decrease the threshold temperatures to adapt them to the crystallization temperature of the polymer.

The method of the present invention comprises at least three steps as outlined before. The time period for treating an element is dependent on various factors such as material, shape and size of the element to be treated, the type of treating liquid, temperature and pressure applied, surface roughness of the element to be treated among others.

In said heating step a) the treating liquid comprises and is in contact with the polymer elements to be treated during heating, or said heating step a) comprises that the treating liquid is heated at least to the lower threshold temperature, up to the upper threshold temperature or beyond, and that the polymer elements are separately heated in an aqueous solution to a temperature below the upper threshold temperature, and wherein in said step b) the treating liquid and the polymer elements are contacted for smoothing.

In said heating step a) the treating liquid and optionally the polymer elements are heated to a temperature below the temperature used for smoothing. In one embodiment treating liquid and polymer elements are heated together such that smoothing does not start, i.e. up to a temperature below a lower threshold temperature. Preferably, for this embodiment in step a) the treating liquid with polymer elements is heated to a temperature in the range of about 80° C. to about 170° C. for a time period of about 5 seconds to about 24 hours.

In another embodiment, the treating liquid is heated separately from the polymer elements and is added to the polymer elements only for the smoothing step. In this embodiment the treating liquid can be heated to a temperature between a lower threshold temperature and an upper threshold temperature or even beyond, as temperature of the liquid will decrease when contacted with the elements.

Both embodiments have advantages. When heating liquid and elements together, the process is simple. When heating liquid and elements separately, the process is more flexible and energy can be saved.

According to a preferred embodiment of the invention, said heating step a) may be carried out at a temperature in the range of about 80° C. to about 170° C. for a time period of about 5 seconds to about 24 hours. According to another preferred embodiment of the invention, in said smoothing step b) a temperature above the lower threshold temperature and 1° C. to 15° C. below the upper threshold temperature may be maintained for a time period of about 3 seconds to about 20 minutes.

There are two critical points in the process of smoothing: the upper threshold temperature and the lower threshold temperature. Both temperatures can be determined by a skilled person as described below. When treating the polymer elements care has to be taken that the elements are not exposed to temperatures exceeding the melting temperature of the polymer from which the elements have been built. Therefore, the upper threshold temperature is below the melting temperature, at most 1° C. below and can be in a range of about 1° C. to 80° C. below the melting temperature. The upper threshold temperature is specific for the combination of treating liquid and polymer used in the process. It is the temperature beyond which the element is at least partially distorted or destroyed. This is the upper limit for the smoothing step. The lower threshold temperature is the temperature for a specific treating liquid and a specific polymer, where smoothing starts.

This temperature can be determined as described below. Thus, said smoothing step b) is carried out at a temperature which is between the lower threshold temperature and the upper threshold temperature and is preferably close to the upper threshold temperature, for example 1° C. to 30° C., such as 2° C. to 15° C., usually 2° C. to 10 ° C. below the upper threshold temperature. The lower the temperature is and the closer to the lower threshold temperature, the longer the time period needed for smoothing will be. Smoothing time periods of more than 15 minutes are less preferred as longer treating times might result in destructuring of the element and there will be a risk of lower quality. Time periods in the range of about 10 seconds to about 10 minutes, such as about 20 seconds to about 5 minutes have been found useful. The closer the treating temperature is to the upper threshold temperature, the faster the smoothing reaction and the shorter the time period for smoothing will be. The upper threshold temperature is specific for each combination of a treating liquid and a polymer and is also dependent on the device and the conditions used for the smoothing process.

Smoothing of the polymer elements cannot be carried out at a temperature beyond the melting point of the polymer, as the elements would be destroyed immediately. However, at a temperature slightly below the melting point of the polymer good results can be achieved. Thus, the upper threshold temperature is in a range of about 1° C. to about 80° C. below the melting point and can be determined for a specific combination of treating liquid and polymer. A temperature range that is suitable for a water-ethanol-mixture as treating liquid for treatment of polyamide elements is about 120° C. to about 170° C. under conditions where the treating liquid is in liquid form.

For determining the upper threshold temperature, polymer elements are contacted with a treating liquid at a predetermined temperature for about 30 seconds or up to 2 minutes and thereafter are immediately cooled. Typical cooling rates are between 1° C./minutes up to 60° C./minutes. Afterwards, the elements are analyzed. If the elements have been destroyed or the surface shows signs of deterioration treatment was beyond the upper threshold temperature and the test will be repeated at 5, or 1 or 2° C. lower, respectively. If the element has an intact surface the test can be repeated at a slightly higher temperature, such as 1 or 2° C. higher. With a few experiments the upper threshold temperature is found.

The lower threshold temperature is the other critical temperature for the process of the present invention. The lower threshold temperature is the temperature where smoothing starts. It is specific for any combination of polymer and treating liquid and can be determined as follows. Elements obtained by additive manufacturing from a specific polymer, such as polyamide, are contacted with a treating liquid with a predetermined composition, for example a combination of ethanol and water with a ratio of ethanol to water of 60:40. The treating liquid in contact with the elements is heated to a temperature under conditions where the treating liquid is in liquid form and this temperature is maintained for a predetermined time period, for example for 1 to 10 hours, such as 2 to 6 hours. After this predetermined time period the elements are cooled and examined if a smoothing has taken place. If the elements don't show any and/or minor sign of smoothing, the test temperature is below the lower threshold temperature. If there are minor signs of smoothing, the temperature is close to or at the lower threshold temperature. As already stated above, the lower threshold temperature is the temperature where smoothing starts. In other words, elements can be stored in the treating liquid for long time provided the temperature is below the lower threshold temperature. It may be advantageous to store elements to be treated for some time, such as for 5 minutes to 24 hours, for example for 15 minutes to 10 hours, particularly for 30 minutes to 5 hours in the treating liquid at elevated temperature but below the lower threshold temperature. On the one hand, it can be an advantage when the elements to be treated have already a temperature close to the smoothing temperature. On the other hand, it has been found that pre-treating elements at a temperature below the lower threshold temperature either with the treating liquid or with water or with a mixture of water with a lower amount of alcohol can be beneficial as the surface of the elements is saturated with water. This might increase the buffering function of water during the smoothing process, i.e. can delay a reaction which otherwise would be too fast or could destroy the elements.

Without being bound by theory it is assumed that particularly favorable results can be obtained when the upper threshold temperature is in the range of the crystallization temperature of the polymer. It seems that the smoothing process achieves the best results when smoothing occurs at about the crystallization temperature of the polymer. As can be seen in the examples, experiments have been made with polyamide, preferably PA12 (PA2200) having a crystallization temperature between 135° C. and 150° C. When using a treating liquid comprising about 40% ethanol and 60% water it has been found that the upper threshold temperature when using a polyamide and when providing conditions such that this treating liquid is in a liquid state is 148° C. Polyamide elements have been treated with this treating liquid for a time period of about 10 to 20 seconds and have been cooled thereafter. A surface with an Rₐ of about 1 to about 5 μm can be obtained.

The smoothing process and the quality of the elements obtained in many cases can be further optimized by a pre-heating step, by monitoring and controlling the cooling time and optionally by post-treatment.

It was found that the time period wherein the elements are in contact with the treating liquid at a temperature below the lower threshold temperature are uncritical, in the sense that the elements can be maintained in the treating liquid for as long as up to 48 hours without harm. Critical is the time period starting at the lower threshold temperature. As soon as the temperature is above the lower threshold temperature, the smoothing process starts, slowly in the beginning and becoming very fast the closer the temperature is to the upper threshold temperature. The time period for keeping the elements in contact with the treating liquid at a temperature between the lower threshold temperature and about 1° C. to 15° C. below the upper threshold temperature depends on the heating rate and can be adjusted.

In this temperature range heating can be very fast, fast, or slow depending on the size and shape of the elements, in particular depending on the presence of channels, holes, internal cavities etc. Smoothing becomes very fast close to the upper threshold temperature. Therefore, the time period for maintaining the elements in a temperature range between 5 and 0.5° C. below the upper threshold temperature should be in the range of up to 2 minutes, preferably 5 seconds to 1 minute, such as 10 to 30 seconds. The time period for smoothing depends on the wall thickness and on the elements' size and will be longer for bigger parts and shorter for small parts. The time period also depends on the heat rate during heating. The time period for smoothing can be up to 30 minutes, such as 1 second up to 15 minutes and is preferably about 20 seconds to 10 minutes. The higher the heating rate, the shorter will be the time period for smoothing.

Moreover, it was found that contacting the elements to be treated with water or with the treating liquid in a pre-treatment step can improve the smoothing results. As such contacting below the lower threshold temperature tends to be not critical the time range tend to be uncritical. Without being bound by theory it is assumed that by maintaining the elements at a temperature below the lower threshold temperature for some time, such as at least for 30 minutes, for example for 1 to 24 hours in water or in a water-alcohol-mixture allows the elements adsorbing or soaking water into their surface. The water adsorbed or soaked into the outer surface layer of the elements may act like a buffer which adapts the smoothing action of the alcohol which can be very strong, so strong that it can destroy elements when the temperature is beyond the upper threshold temperature. Therefore, for optimizing the quality and the surface of the elements a pretreatment step may be an option. This step can be carried out at any temperature below the lower threshold temperature, for example at about 20 to about 100° C. This pretreatment step can also be used to “preheat” the elements and/or the treating liquid and can, thus, contribute to acceleration of the smoothing step.

A further parameter of the method is the heating rate of the elements in step a) and/or step b). In step a) heating is uncritical and many variants are possible. The heating rate in step b) is more critical as it has influence on the smoothing time and the quality of the elements. Typical heating rates when heating elements in or together with the treating liquid are about 0.5° C./min up to about 30° C./min, such as 2° C./min up to about 10° C./min.

As soon as the smoothing period is finalized, the elements are cooled in step c). It has been found that when using the treating liquid of the present invention the smoothing stops very fast when cooling starts, i.e. when the elements and the treating liquid, respectively, are cooled to a temperature of more than 5° C. below the upper threshold temperature. Without being bound by theory it is assumed that the surface of elements is soaked with water which acts like a buffer and avoids that alcohol reacts outside the smoothing temperature or about 5° C. below. As the smoothing reaction is delayed and more or less stopped as soon as the temperature is about 5° C. below the upper threshold temperature, the smoothing time period can be determined very accurately so that optimal smoothing can be obtained.

According to a preferred embodiment of the invention, in said cooling step c) the treating liquid with the smoothed polymer elements may be cooled for a time period of about 1 minute to about 48 hours and/or the treating liquid may be at least partially substituted by a cooling fluid, wherein preferably the cooling fluid is water. Generally it was found that when using the treating liquid of the present invention, the temperature range for smoothing is between about 100° C. to about 190° C., such as about 120° C. to about 180° C. A preferred temperature range is about 130° C. to about 160° C. As outlined before, this temperature range depends on the composition of the treating liquid and the polymer the elements are built from. When the relative amount of alcohol is high, the smoothing activity of the treating liquid is high and the upper threshold temperature is lower. If the relative amount of alcohol is low, the active part of the treating liquid is low and water weakens the activity. In this case the upper threshold temperature is higher. If the solvent is applied for a longer time period, the element softens, contours can become blurred or delicate parts or channels can be destroyed.

As outlined above, it is assumed that it is preferable that the upper threshold temperature is in the range of the crystallization temperature of the polymer to be treated. If the crystallization temperature is high, it can be useful to increase the upper threshold temperature of the treating liquid to have optimal conditions for the smoothing reaction. In this case an additive can be used for decreasing the smoothing activity of the alcohol or for increasing the upper threshold temperature. Such additive is a solvent which can be added to the treating agent in an amount up to about 20 weight-%, such as up to about 10 weight-%. Examples for delaying additives are polyvalent alcohols like glycerol or glycol.

Depending on the material of the elements the best suited treating liquid can be identified. Some examples are described in detail below. The shape of the element has to be considered as delicate structures are more sensible to treatment than simple structures like cubes. For complex structures it can be preferred to use short treatment periods. If an element has many channels, holes, or cavities it can take longer to smooth the complete surface, whereas for a small element and/or an element with a simple shape, smoothing can occur faster, for example within a few seconds up to about a minute.

Moreover, the time of application also depends on the initial surface roughness. For example, elements that have been obtained by SLS usually have a higher initial surface roughness than elements that have been obtained by MJF or HSS. Therefore, the time period for getting smooth surfaces can be higher for SLS elements than for MJF elements.

The method of the present invention can be carried out in any device known for contacting elements with a liquid. When using a chamber with a microwave unit and/or an ultrasonic unit the conditions can be adapted accordingly.

After treatment the elements can be removed from the treatment chamber and dried or can be functionalized in a further step. Drying can be achieved by storing the smoothed elements in an oven or dry box, optionally using means like a fan or any other means known to remove remaining treating liquid. The drying time is not critical and can be from about 5 minutes up to hours or even days such as 1 to 24 hours.

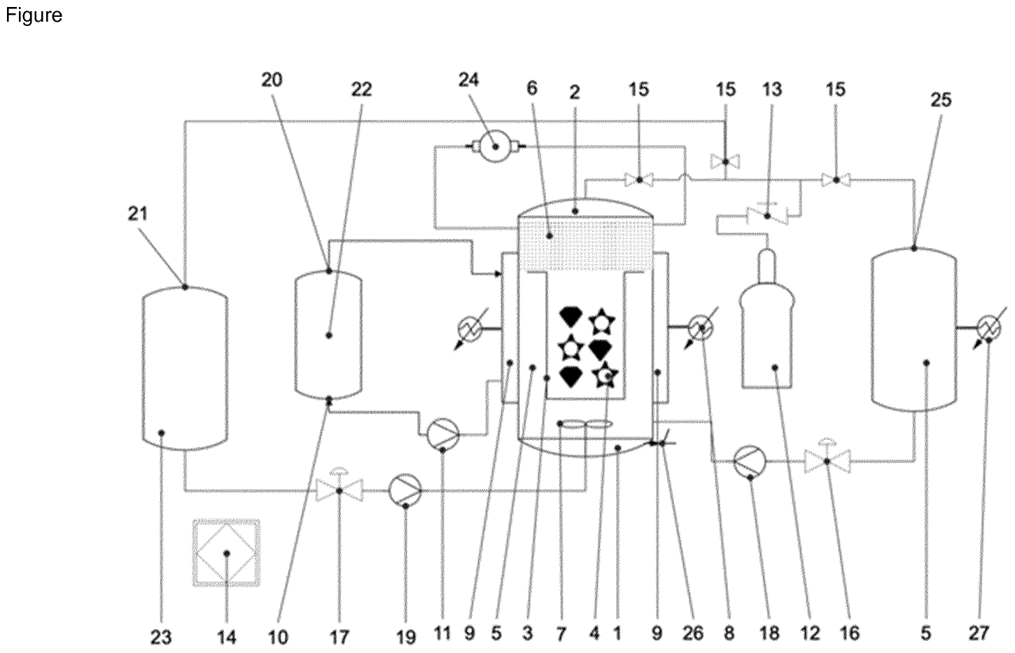

Treating polymer elements with the method of the present invention can be done in any suitable device. The polymer elements for example can be treated in a device as claimed in the present application and as shown in FIG. 1, which comprises a chamber 1 with a lid 2, at least one container for receiving the polymer elements and the treating liquid 5, and means for temperature control 26, wherein preferably the device further comprises at least one of a circulation device 7, a heating device 8 and a coolant tank 10, 20 comprising a cooling fluid 22. This device is described and explained in more detail below and in the example.

For the application of the water-alcohol-mixture, for example a water-ethanol-mixture, a pressure vessel can be used. The pressure vessel is equipped with a lowerable platform for positioning the elements. The elements can be arranged in any possible form, for example, the elements can be suspended under the platform by suspension means and/or can be arranged on a platform, for example as bulk material in a perforated or slotted tank or on a grid. Possibilities of the component-specific storage or the different clamping and suspension variants are described below. The advantage is that using a treating liquid of the present invention lets the elements flow and they can be treated without adhering to another.

For circulation of the treating liquid it can be useful to use an agitating device, such as a distributor, an impeller, or a turbulator. Devices useful for agitating or stirring such as stirring bars, impellers etc., are known to the skilled person. Any means used in a device or method of the present invention must be chemically resistant to the treating liquid and should withstand temperatures as used, for example of more than 170° C. when the upper threshold temperature is high.

Control mechanisms are known to the skilled person and can be electrical, pneumatic, hydraulic or a different type of drive. The platform with the elements remains in the treating liquid during the set process time.

Some embodiments for treating elements are outlined below. Each step that is described can be combined with other embodiments as long as there is no contradiction and as long as the context allows.

It is also possible to provide two containers with liquids inside a pressure container. These containers are preferably open at the top. One liquid is the treatment liquid for smoothing the elements at elevated temperature, such as a water-ethanol-mixture. The second liquid can be a process-inhibiting agent or an inert solvent such as glycerol or water or a functionalizing agent such as a colorant or dye. A mechanical manipulator such as a gantry crane transports the elements between the two containers according to the process description.

The method for treating elements according to the present invention can further comprise steps for functionalizing the elements. Preferably, in at least one step at least one functionalizing agent may be applied to the polymer elements during or after treatment with the treating liquid. More preferably, at least one functionalizing agent may be applied during or after said step c), wherein the method preferably further may comprise a step d) for functionalizing the smoothed polymer elements by applying at least one functionalizing agent.

During at least one of said steps a) to c) and/or during said functionalizing step d) means for impelling the treating liquid and/or the functionalizing agent may be used, wherein preferably the impelling means is at least one of an impeller, a microwave unit, and an ultrasound unit.

The functionalizing agent may comprise at least one agent selected from a colorant, a dye, a pigment, a fiber, a hardening agent, a metal powder, a polymer powder, an inorganic pigment or powder, an electrostatic discharge agent, a filler, a base, a finishing agent, and/or a plasticizer. Preferably, a colorant or dye solution may be applied in said functionalizing step d).

It has been found that by control of process temperature and process time mechanical or dynamic properties of polymer elements that are treated with the method of the present invention can be changed in a controlled manner, such process control can also have an effect on the micro surface or the options for post-treatment processes. Thus, a matt surface with very smooth surface values can be created by appropriate process control. For post-treatment of the elements such as coating, galvanizing, bonding or other post-treatment steps, a process carried out in this way can bring advantages in terms of adhesion by, among other things, positively changing the surface tension of the component surface for the respective process.

In most cases an element is treated with treating liquid such that the whole surface is in contact with treating liquid and, thus, is smoothed. If only part of an element shall be smoothed, then only this part should be in contact with the treating liquid. This can be achieved by excluding that part of the element that shall remain untreated from contact with the treating liquid and/or by protecting it from contact with the treating liquid, for example, by applying a protective layer on that part of the element that shall remain untreated, for example, by applying a layer, like a wax layer or a silicone layer, particularly a removable layer.

A further advantage has been found for elements that comprise carbon black, and, therefore, have a black or grey surface and are difficult to dye. It seems that a polar liquid like water or a salt solution, for example an aqueous solution comprising about 1 to about 20 weight-% of a salt like NaCl or Na₂CO₃ is soaked in by the elements and displaces carbon black in the interior of the element, the surface becomes whitish or light grey and can be dyed easier and more efficient than black or dark grey elements. Whitening occurs in particular at a temperature above the crystallinity temperature of the polymer. Thus, in one embodiment polymer elements obtained by additive manufacturing comprising carbon black may be treated with water or an aqueous salt solution at a temperature in a range of about 130° C. to about 175° C.

Even better elements having a white or light grey surface, that have been treated by the method of the present invention can be dyed as the surface after treatment is smooth but not dense or compressed. The elements can be dyed as is known in the art with any type of dyes that are used for dyeing such polymers. If a dye is used that is soluble in the treating liquid, smoothing and dyeing can be carried out in one step. If a dye is not soluble in the alcohol used as treating liquid, a solubilizer for the dye can be added, such as an organic solvent.

It has been found that a treatment of elements comprising carbon black with salt as described above can be generally used for elements to improve the colour. This step can be carried out without a smoothing step or method or with or after other smoothing methods.

Examples for dyes that are useful in the method of the present invention are acid dyes, basic dyes, reaction dyes, sulfur dyes, dispersion dyes, metal complex dyes, etc. and mixtures thereof. The elements can be dyed in many color tones, hues, tints, and shades.

Elements obtained by treatment according to the present invention have a smooth surface which hardens and is mechanically strong and can have any color, such as a white or black color or a color tone which can be obtained as desired by dyeing. These elements can be used as they are, they can be stored until they are used, or they can be treated further with a functionalizing solution to improve or change the properties, and/or to make the surface of the element harder, glossier, more brilliant or texturized. It has been found that elements that have been treated with the method of the present invention can be dyed at lower temperatures than elements of the prior art, for example at less than 100° C. and nevertheless a brilliant uniform surface can be obtained. Moreover, it has been found that when dyeing elements of the present invention, less dye is necessary and there is no need for the application of pressure. Without being bound by theory it is assumed that when using mechanical means for smoothing a surface of an element, densification or closing of pores and cells at the surface can occur, whereas the surface of elements that have been smoothed with the method of the present invention is not densified. Therefore, elements that have been smoothed by the method of the present invention take up the dye from a dye solution more easily, no pressure or high temperatures are necessary and the surface takes up the dye even if the dye solution is not supersaturated. This allows getting good and reproducible results even with less concentrated dye solutions.

Furthermore, smoothing and dyeing of elements can be done simultaneously or independently in any order, which makes the process very versatile. In one embodiment elements are first smoothed and then dyed, in another embodiment elements are first dyed and then smoothed. Dyeing can be done in the same process line as smoothing or elements can be smoothed, stored and dyed when desired or necessary. Thus, dyeing and smoothing can be carried out independently from each other.

Elements, in particular white elements that have been treated by the method of the present invention have a smooth surface that can be dyed by conventional dyeing processes. These elements can be dyed in many different tones because of their smooth white surface which has not been densified by mechanical treatment.

In case a powder-based manufacturing method has been used for producing the elements, an essential advantage provided by the method of the present invention is that the surface is smooth and does not or hardly comprise any powder because any powder that remained on the surface after additive manufacturing is removed or melted or fused by the treatment according to the present invention.

Another advantage is the mechanical strength, in particular the fatigue strength of the elements. Without being bound by theory it is assumed that by treating elements with the method of the present invention boundary stress is reduced and molecular chains are reordered or restructured with the result of a smoother and stronger surface.

The method of the present invention allows not only smoothing but also functionalizing elements to improve their properties such as gloss, texture, mechanical strength, electrical properties, such as electrostatic charge etc. This is achieved by contacting the elements with a functionalizing agent together with treating liquid or directly after treatment with the treating liquid as long as the surface of the element is still soft.

A functionalizing solution or functionalizing agent can be applied to the element either together with the treating liquid or to the element obtained after application of the treating liquid. A functionalizing agent is any agent that provides the surface with positive properties, such as appearance, color, and/or texture. A functionalizing agent can provide for a hard and/or glossy surface, a deep black surface or a surface in a desired color tone, a specific texture of the surface, a metalized surface that optionally can be galvanized afterwards, i.e. a priming layer for galvanization, or a surface that avoids electrostatic charging. The functionalizing agent can also comprise fibers, powder or other reinforcing agents, which can either result in a reinforced layer and/or in a texturized layer. It is also possible to use a plasticizer as functionalizing agent to provide for a smooth and soft surface. These functionalizing agents can be used as known to the skilled person, i.e. in concentrations, at temperatures and in time periods that are usually used for such agents. The method of the present invention allows using such functionalizing agents and providing functionalized surfaces in an easy way. Thus, the method of the present invention is very versatile and allows the creation of different surfaces.

For application the functionalizing agent can either be dissolved in the treating liquid comprising water and at least an alcohol and optionally an additional solvent or it can be dissolved in another solvent and can be applied together with the treating liquid. It is also possible to apply a solution of the functionalizing agent shortly after the smoothing step, for example within 1 to 20 minutes after the smoothing step. It is also possible to apply a functionalizing agent in powder form either dispersed in the treating liquid or as separate dispersion together with the treating liquid or after application of the treating liquid as long as the surface of the element is still soft or adhesive. For example a dispersion of treating liquid and powdered functionalizing agent can be used.

It has been found that when using a powder, such as a metal powder, it is one option to use a vaporization chamber with a microwave unit and/or an ultrasound unit for the contacting step with solvent vapor. In particular metal powder with particles in the nanometer range can be distributed in high density and with high uniformity by microwaves and/or ultrasonic waves. Microwaves and/or ultrasonic waves provide that the vapor created smoothens the surface and distributes the functionalizing agent very uniformly. Another option is to apply functionalizing agent together with or after treatment with treatment agent in liquid/fluid/dispersed form. For example the functionalizing agent can be provided in liquid form in a container and the elements can be dipped into it.

As the method of the present invention results in elements with a smoothed surface without densifying the surface layer, these elements can be dyed with good results with acid dyes, dispersion dyes, sulfur dyes or other dyes known for dyeing polymers used for additive manufacturing processes, such as polyamide. Thus, a dyed and smooth surface with high quality is obtained. Examples for dyes that are useful for dyeing polyamide are C.I. Acid Red dyes, C.I. Acid Blue dyes, C.I. Acid Yellow dyes, C.I. Acid Black dyes, C.I. Acid Orange dyes, or mixtures thereof, such as CI Acid Red 1, CI Acid Red 138, CI Acid Red 52, CI Acid Blue 40, Nylason red N-2RBL, or mixtures thereof. The acid dyes can for example be used in a concentration of about 0.01 to about 7.5 wt.-%.

As the elements obtained by the treatment of the present invention have a smooth surface without densification by mechanical means, the temperature for dyeing can be lower than for elements obtained with prior art processes. For example, it has been found that dyeing can be done at a temperature of about 40 to 130° C. The time for dyeing can be in a range of about 10 to about 180 minutes.

Generally, after finalizing the treatment steps a)-c) the element is taken out of the device and dried. Any remaining liquid should be removed and the element can be dried as is known to the skilled person, for example by just leaving the element in open air, or by heating, using an air stream or jet stream or any other means that is usually used for drying elements or components.

The method of the present invention smoothens the surface of elements that have been obtained by an additive manufacturing process using building material in powder form, where the elements have a roughness Rₐ of the surface of the elements before treatment in the range of up to 20 μm, such as 1 μm to 15 μm. By treatment in accordance with the present invention the elements can be smoothed to reduce the roughness by up to about 15 μm, such as about 5 to about 10 μm, such that the roughness after treatment for example is in the range up of about 10 μm, such as about 0.3 to about 6 μm, for example 1 to 4 μm. According to a preferred embodiment of the invention, the treating liquid may be applied until the surface roughness of the polymer elements has been reduced by 1 to 20 μm.

Further reduction of roughness can be obtained by using more than one treatment run. The smoothing effect can be obtained with or without mechanical pre-treatment. Furthermore, the method of the present invention has further advantages as the steps can be carried out easily and can be automatized at least in part.

In a further embodiment of the present invention a mechanical step can be carried out after treatment of elements with the treating liquid as long as the surface of the elements is still soft. In some cases treatment with glass balls or jet stream and/or open air plasm can further smoothen the surface.

The method of the present invention can optionally comprise a further step—a post-processing step wherein elements that have been subjected to treatment with a treating liquid are contacted with a post-processing composition, which can be a colorant, such as water or an aqueous solution, immediately or up to 25 minutes after treatment. The contact with water or an aqueous solution provides for a fast solidification of the surface and, thus, avoids sticking together of elements and damage of the surface. The composition of the aqueous solution is not critical as long as it does not have a detrimental effect on the elements or the elements' surface, respectively. Suitable as aqueous solution is for example a mixture of water and a polyvalent alcohol, such as a mixture of about 1 weight.-% to about 25 weight.-% of a polyvalent alcohol and water. A suitable polyvalent alcohol is for example diethylene glycol, water can be distilled water. The temperature of the post-processing composition is not critical. Ambient temperature may be suitable and most convenient. In other embodiments a temperature below ambient temperature may be useful. It has been found that the result can be improved by using water or an aqueous solution with a temperature in the range of about 0° C. to about 20° C.

Post-processing of elements obtained after the smoothing step by drying in an oven or by using vacuum for drying can further improve the result.

The method of the present invention can be carried out in devices that have been developed for treatment of elements with treating liquid. A device that is particularly suited for treating elements is also a subject of the present invention.

All embodiments described with regard to a device as shown in FIG. 1 can be combined with an additional dyeing and/or functionalization step by introducing suitable substances into the process chamber 1 either during the smoothing step and/or thereafter, for example in a time window after smoothing as described before.

The invention is further explained by the following figure and the examples which are not deemed to be restrictive.

FIG. 1 shows a device for carrying out the method of the present invention.

The device comprises:

1 Process chamber

2 lid

3 Inner container

4 Elements

5 Treating liquid

6 Process steam

7 Circulation device

8 Heating device

9 Cooling line/cooling device

10 Coolant tank

11 Pump

12 Process gas

13 Pressure relief valve

14 Control (not shown)

15 Gas valve

16 Valve for treating liquid

17 Valve for functionalization fluid or component cooling fluid

18 Pump

19 Pump

20 Coolant tank

21 Container for functionalization fluid or component cooling fluid

22 Coolant

23 Functionalizing liquid or component coolant

24 Vacuum pump

25 Reservoir for treating liquid

26 Temperature sensors and pressure sensors

27 Heating device in storage tank

The device is explained exemplary without restricting the scope by this embodiment.

A process chamber 1 is designed as a pressure vessel and can be closed with a pressure-resistant lid 2. The elements 4 can be introduced into the process chamber 1 by means of an inner container 3 either as bulk material or in special chambers and/or holding devices (not shown) on and inside the inner container 3. The treating liquid 5 can be introduced into the process chamber 1 in various ways. A circulation device 7, preferably an impeller, is capable of continuously stirring the treating liquid 5. Chambers and/or fixtures can be useful if the elements 4 tend to stick together during smoothing. This depends, among other things, on the elements' geometry and the polymer used as well as on the smoothing intensity to be applied. The circulation device 7 prevents sticking together in a certain area by constant stirring. As described above, the treating liquid 5 can be introduced in different ways. In a first variant, the elements 4 are introduced into the process chamber 1 and the lid 2 is closed pressure-tight. The Treating liquid 5 is then introduced into the process chamber 1 from the reservoir 25 by means of a pump 18 and/or pressurisation by means of process gas 12 according to a predetermined level. The process chamber 1 can already be filled with process gas 12 under a certain pressure in advance in order to generate a counterpressure during the introduction phase of treating liquid 5 and/or to strongly prevent a sudden evaporation of treating liquid 5. The conditions should be such that the treating liquid 5 is in liquid form. In a special design, a vacuum pump 24 ensures the displacement of almost any oxygen inform the process chamber 1 before any gases or liquids are introduced into the process chamber 1. An ideal (filling) level for the treating liquid 5 depends on various factors. It is useful to not fill the entire process chamber 1 with treating liquid 5 and so that process steam can fill the remaining space. 6. If necessary, the treating liquid 5 can be heated to a temperature of about the lower threshold temperature of the treating liquid 5, where the lower threshold temperature not only depends on the concentration and composition of the treating liquid 5 but also on the polymer used in the elements 4 and can also depend on the manufacturing process. If there is sufficient treating liquid 5 in the process chamber 1, the valve 16 can be closed. Process gas 6 is then preferably introduced into the process chamber 1. At the same time or afterwards the circulation device 7 can be switched on to distribute or circulate the treating liquid 5 and the elements 4. The treating liquid 5 and the elements 4 are brought to the required smoothing temperature by means of a heating device 8. This is preferably done with a comparatively high to very high heating rate. To control the temperature of the treating liquid 5 as exactly as possible, a control 14 is provided, within the process chamber 1. Preferably, the temperature is monitored continuously and very accurately by means of temperature sensors 26 and means are provided to heat as exactly as possible to the predetermined smoothing temperature with a predetermined heating ramp. A very fast heating rate is desirable as well as maintaining the temperature within a predetermined temperature range. Means (not shown) for a non-linear temperature rise, temperature ramps and/or a certain inert temperature rise or fall by a few ° C. after reaching the smoothing temperature can be provided to further improve the process. After a predetermined smoothing time, the temperature is decreased to the range of the lower threshold temperature at a predetermined cooling rate, which is advantageously high to very high. This is preferably done via a cooling line 9 within the process chamber 1, which is supplied with a coolant 22, preferably water, by a pump 11. Additionally or alternatively other means for cooling can be used, such as applying liquid nitrogen, or a discharging process steam. After reaching the lower threshold temperature, the treating liquid 5 can be pumped back into the storage tank 25. Optionally, the elements 4 can be further treated by means of a rinsing liquid or a downstream dyeing and/or a functionalizing liquid 23 provided from a further container 21 by means of a pump 19 into the process chamber 1, before this liquid is pumped back into the container 21 after the downstream treatment. The functionalizing liquid 23 can be simple water at room temperature in order to reduce the residual temperature of elements 4 and process chamber 1 to approximately room temperature as quickly as possible in order to be able to remove the treated elements 4 after opening the lid 2. The process can be repeated.

To save energy it can be of advantage to heat the elements 4 and the treating liquid 5 separately and to recover the treating liquid 5 during cooling below the lower threshold temperature. This can be done by using a configuration, wherein the treating liquid 5 is heated to a temperature in the range of the upper threshold temperature or beyond in a separate container or reservoir (not shown). The heated treating liquid 5 can then be pumped into the process chamber 1 comprising the elements 4 and or comprising the elements 4 and water or an aqueous solution for pretreatment. If the treating liquid 5 with a temperature in the range of the upper threshold temperature or beyond is fed into the process chamber 1, the temperature will be slightly lowered by the lower temperature of the elements 4 and the thermal mass of the process chamber 1. This allows fast heating of the elements 4 to the smoothing temperature and a fast smoothing action.

### EXAMPLE 1

Elements were smoothed with the method of the present invention. Elements first were treated at a temperature below a lower threshold temperature, where time is not critical. Only when this temperature is exceeded a noticeable reaction does take place at all. Below the lower threshold temperature, no smoothing or change of the surface occurs neither in a few minutes nor over a period of some hours. This means that the elements can remain in the treating liquid or another pre-treatment liquid like water or an aqueuos solution for any time period. This allows high flexibility for the process. The lower threshold temperature depends on the treating liquid and on the type of elements to be treated. Thus, the lower threshold temperature can vary depending e.g. on elements produced with different manufacturing processes such as SLS and MJF. It can generally be assumed that this lower threshold temperature is at least about 5° C. and up to about 50° C. or more below the upper threshold temperature.

The “lower threshold temperature” may not necessarily be an exact temperature value but can be a temperature range comparable to the melting range of a polymer. Thus a lower threshold temperature of x° C. may include temperature values between (x−1)° C. and (x+1)° C. The same may apply to the upper threshold temperature. As smoothing beyond the lower threshold temperature starts slowly, this is not critical as long as any pre-treatment that should not start smoothing is carried out well below the lower threshold temperature. When polyamide elements are treated and the treating liquid is a water-alcohol-mixture with a ratio of water to alcohol of about 60:40 to about 40:60, the lower threshold temperature is usually higher than 100° C. and lower than 145° C.

Until the lower threshold temperature is reached, the heating rate plays no significant or direct role for the element quality. The actual smoothing process starts slowly as soon as the lower threshold temperature is reached. This temperature can be maintained for some time or alternatively or additionally, one or more temperature holding cycles can be set up for heating the treating liquid and optionally the elements to about the lower threshold temperature. These holding cycles or alternatively a delayed heating rate can be of advantage to saturate the elements with water by using an aqueous medium such as water, or a water-alcohol-mixture. In other words the elements can be pre-treated with water or an aqueous liquid or the treating liquid before the smoothing step as such starts, which means the elements can be contacted with an aqueous medium at a lower temperature and can be heated slowly or can be hold at a temperature below the lower threshold temperature for any useful time period. Smoothing begins when the treating liquid is heated to a temperature higher than the lower threshold temperature. Different approaches for heating are possible.

In one approach the treating liquid with the elements therein is heated very quickly from the lower threshold temperature to the upper threshold temperature. The heating rate should preferably be high to very high. Temperature should be controlled as precisely as possible. In addition to the generally known heating characteristic, it is preferable to control and detect possible energetic fluctuations in the process chamber through evaporation and to provide means to counteract these in a process-enhancing way, for example by providing circulation or impelling means. Once the upper threshold temperature or a temperature close to it, such as 1 to 5° C. below the upper threshold temperature has been reached, this temperature can be maintained for a short period of time, such as some seconds up to about a few minutes. The temperature regimen can be adapted to achieve optimal results for example by using a predetermined heating rate until a desired temperature like 1 to 5° C. below the upper threshold temperature has been reached, holding this temperature for some seconds or up to about 2 minutes, and then cooling with a predetermined cooling rate. Heating rate and holding time can be adapted for optimal results and the cooling rate can also be adapted accordingly. For example means can be provided to allow for a shorter or longer holding time and adaptation of temperature ranges, by fast or slow temperature increase and/or decrease. In general it is preferred to have a fast temperature increase to the predetermined smoothing temperature and a fast decrease of temperature down to the lower threshold temperature to stop smoothing as fast as possible. Time periods for increase and decrease in the range of less than 5 minutes, preferably of less than 2 minutes are preferred.

The smoothing step is followed by a cooling step, where the temperature inside the process chamber is lowered. This can be done with any means known in the art and can be done as quickly as possible and/or in a controlled manner, at least until the lower threshold temperature has been reached, preferably by means of active cooling media. Examples for active cooling means are pipe cooling lines arranged within the process chamber or cold exchangers. A further possibility to rapidly lower the temperature can be achieved by selectively discharging process gas within the process chamber, preferably into a third chamber. By selectively discharging process steam in a deliberately arranged gas area above the actual treating liquid within the process chamber, further steam is generated from the liquid, which leads to a cooling of the treating liquid.

Typical heating rates from the lower threshold temperature to the upper threshold temperature are about 1° C./min up to about 60° C./min, such as about 5° C./min to about 20° C./min. Cooling rates can be in the same range, but can also be slower or faster.

In an alternative design, the treating liquid, for example an ethanol-water mixture, is not heated each time from about room temperature to the lower threshold temperature, but pumped after the smoothing step into a second chamber, where it can be kept at about the same temperature and can be used again for the next charge of elements to be smoothed. In another approach the ethanol-water mixture is heated separately to a temperature higher than the lower threshold temperature, such as to the upper threshold temperature or beyond within a second chamber. The temperature of the treating liquid in this approach at most should be such that when the treating liquid is contacted with the elements to be smoothed the temperature drops during pumping from the second chamber into the process chamber and/or by the contact with the elements down to about the upper threshold temperature. In the process chamber, this temperature can either be maintained as a function of the initial temperature and the thermal mass of the process chamber wall and the elements, or it can be adjusted to the optimum upper threshold temperature by active heating or cooling. After a predetermined treatment period at the preferred smoothing process parameters or within the preferred smoothing process parameter ranges, the temperature of the treating liquid is brought below the lower threshold temperature again by the cooling options already described. The treating liquid can then be pumped back into a second chamber.

In another approach, the treating liquid 5 from the reservoir 25 is not cooled to or below the lower threshold temperature but, preferably in a second chamber, is maintained at a temperature, that is suitable for smoothing, such as slightly above or at the upper threshold temperature. When the treating liquid 5 at a temperature of about the upper threshold temperature or slightly below or above is fed into the process chamber 1, its temperature will be slightly lowered by the lower temperature and the thermal mass of the process chamber 1 and the polymer elements 4 arranged within the process chamber 1. This approach allows fast heating of the polymer elements 4, in shorter time than by heating the elements 4 directly in the treating liquid 5. Thus, in those cases where fast heating and smoothing is required, this approach is suitable. Heating treating liquid 5 and elements 4 together usually requires more time as the heating device 8 can only bring in a certain heating power.

In an alternative process, the smoothing process can be stopped slower so that the surface of the elements is in a transition phase where the surface is still soft. This is useful if a functionalizing step is carried out following the smoothing step or when a second smoothing step follows. This improves finishing of the surface while maintaining the exact geometric contours. Another way to stop the smoothing process is to introduce liquid nitrogen into the pressure vessel. This can be advantageous when the inlet pressure is kept as low as possible by introducing compressed air and/or process gas.

In an additional step of the method of the present invention or as part of one or more of the steps dyes and/or fillers can be added to the element surface during the process. For this purpose, the alcohol-water mixture is mixed directly with the dye and/or fillers. Dyeing with dispersion, metal complex or acid dyestuffs or sulphur dyestuffs can also be carried out either directly after smoothing or in the process chamber using an additional colour tank (23). Colouring directly after the smoothing process can have advantages in colouring, because the surface still has a certain softness due to the ethanol content, whereby certain dyestuffs or fillers can better and in a shorter time period penetrate the surface under certain circumstances.

In addition to alcohols, substances that increase the polarity of water are able to whiten MJF and HSS components on the surface without being bound to any theory. It is assumed that an increasing polarity of the liquid increasingly displaces the relatively nonpolar carbon black within the mentioned components to the inside, namely at a temperature above the crystallinity range of the polymer. Suitable materials for the white coloration are e.g. tap water or mineral water. However, the temperature must be raised significantly in the range of the crystallinity temperature. If salts are added to the water or water, a white colouring can already occur at temperatures of approx. 140° C. It has been found that generally by treating elements with a salt solution, for example an aqueous solution of a salt like NaCl and/or Na₂CO₃, for example at a concentration of approx. 1% to approx. 20 weight-%, the surface of the elements can become light grey to whitish. This is achieved for elements obtained by additive manufacturing when they contain carbon black, independent from a treatment with a water-alcohol-mixture for smoothing as described above. For the whitening action a salt solution can be used together with the above mentioned additives such as benzyl alcohol, glycerine, glycols or plasticizers, which are used in small quantities.

1. A method for treatment of polymer elements obtained by an additive manufacturing process comprising
a) a heating step for heating a treating liquid to a temperature below an upper threshold temperature, wherein the upper threshold temperature is in a range of about 1° C. to about 80° C. below the melting temperature of the polymer from which the polymer elements are formed,
b) a smoothing step, wherein the polymer elements are in contact with the treating liquid at a temperature above a lower threshold temperature and below the upper threshold temperature for a predetermined time period, under conditions where the treating liquid is in liquid form,
c) a cooling step for cooling the polymer elements,
wherein the treating liquid comprises water and at least one monovalent aliphatic alcohol, wherein the weight ratio of water to alcohol is in a range of about 98:2 to about 20:80.

2. The method of claim 1, wherein the upper threshold temperature is in a range of about 100° C. to about 190° C.

3. The method of claim 1, wherein the at least one monovalent aliphatic alcohol is selected from ethanol, propanol, isopropanol, methanol or a mixture thereof.

4. The method of claim 1, wherein the treating liquid comprises water and ethanol in a weight ratio of about 95:5 to about 30:70 and/or wherein the treating liquid is applied at a temperature in the range of about 100° C. to about 180° C. under conditions where the treating liquid is in liquid form.

5. The method of claim 1, wherein the treating liquid comprises at least one additional solvent and/or at least one plasticizer, wherein the total amount of additional solvent and/or plasticizer is up to about 20 weight-%.

6. The method of claim 5, wherein the at least one additional solvent is substituted or unsubstituted aromatic C₆-C₁₂ alcohols, polyvalent alcohols of glycerol or glycols, esters, ethers, ketones, lactones, DMSO, a salt solution, or γ-butyrolactone, or mixtures thereof, and/or wherein the plasticizer is aromatic esters, aliphatic esters, cycloaliphatic esters, or bio-based compounds.

7. The method of claim 1, wherein a plurality of polymer elements is treated in the same process.

8. The method of claim 1, wherein
either in said heating step a) the treating liquid comprises and is in contact with the polymer elements to be treated during heating, or
said heating step a) comprises that the treating liquid is heated at least to the lower threshold temperature, up to the upper threshold temperature or beyond, and that the polymer elements are separately heated in an aqueous solution to a temperature below the upper threshold temperature, and wherein in said step b) the treating liquid and the polymer elements are contacted for smoothing.

9. The method of claim 1, wherein said heating step a) is carried out at a temperature in the range of about 80° C. to about 170° C. for a time period of about 5 seconds to about 24 hours.

10. The method of claim 1 wherein in said smoothing step b) a temperature above the lower threshold temperature and 1° C. to 15° C. below the upper threshold temperature is maintained for a time period of about 1 second to about 20 minutes.

11. The method of claim 1 wherein in said cooling step c) the polymer elements are cooled to a temperature at least 5° C. below the upper threshold temperature.

12. The method of claim 1, wherein in said cooling step c) the treating liquid with the smoothed polymer elements are cooled for a time period of about 1 minute to about 48 hours and/or wherein the treating liquid is at least partially substituted by a cooling fluid.

13. The method of claim 1, wherein in at least one step at least one functionalizing agent is applied to the polymer elements during or after treatment with the treating liquid.

14. The method of claim 13, wherein at least one functionalizing agent is applied during or after said step c).

15. The method of claim 1, wherein during at least one of said steps a) to c) and/or during said functionalizing step d) means for impelling the treating liquid and/or the functionalizing agent are used.

16. The method of claim 13, wherein the functionalizing agent comprises at least one agent of a colorant, a dye, a pigment, a fiber, a hardening agent, a metal powder, a polymer powder, an inorganic pigment or powder, an electrostatic discharge agent, a filler, a base, a finishing agent, and/or a plasticizer.

17. The method of claim 13, wherein a colorant or dye solution is applied in said functionalizing step d).

18. The method of claim 1, wherein the polymer elements have been obtained by a sintering/melting process.

19. The method of claim 1, wherein the polymer of the polymer elements is a polyamide based polymer or copolymer, a thermoplastic elastomer, thermoplastic polyamide (TPA), thermoplastic copolyester compound (TPC), thermoplastic styrene block copolymers (TPS), acrylic polymers, acrylic ester-styrene-acrylonitrile (ASA), PMMA, POM, PC, PEI, PSU, or polybutylene-terephthalate (PBT), or a copolymer or blend thereof.

20. (canceled)

21. (canceled)

22. A device for treatment of polymer elements obtained by an additive manufacturing process comprising a chamber with a lid, at least one container for receiving the polymer elements and the treating liquid, and means for temperature control.
